(19) United States
(12) Patent Application Publication
(10) Pub. No.: US 2022/0097680 A1
(43) Pub. Date: Mar. 31, 2022

(54) CONTROL DEVICE FOR VEHICLE

(71) Applicants: TOYOTA JIDOSHA KABUSHIKI KAISHA, Toyota-shi (JP); AISIN CORPORATION, Kariya-shi (JP)

(72) Inventors: Keigo MATSUBARA, Nagoya-shi (JP); Masayuki BABA, Toyota-shi (JP); Tomoya INAYOSHI, Anjo-shi (JP)

(73) Assignees: TOYOTA JIDOSHA KABUSHIKI KAISHA, Toyota-shi (JP); AISIN CORPORATION, Kariya-shi (JP)

(21) Appl. No.: 17/480,625

(22) Filed: Sep. 21, 2021

(30) Foreign Application Priority Data
Sep. 30, 2020 (JP) 2020-166513

(51) Int. Cl. B60W 20/40; B60K 6/24; B60K 6/26; B60K 6/387; B60W 10/02; B60W 10/06; B60W 10/08; F16D 48/06

(52) U.S. Cl. CPC B60W 20/40; B60K 6/24; B60K 6/26; B60K 6/387; B60W 10/02; B60W 10/06; F16D 2500/3067; F16D 48/06; B60W 2710/02; B60W 2510/0638; B60W 2510/081; F16D 2500/10412; F16D 2500/1066; B60W 10/08

(57) ABSTRACT

An electronic control unit is configured to: control a clutch actuator based on first phase definition that defines a plurality of stages of progress provided for each of control states of the clutch, the clutch being switched among the control states in a process of starting the engine; and control at least one of a motor and an engine based on second phase definition that defines a plurality of stages of progress, the second phase definition being different from the first phase definition.

### CROSS-REFERENCE TO RELATED APPLICATION

This application claims priority to Japanese Patent Application No. 2020-166513 filed on Sep. 30, 2020, incorporated herein by reference in its entirety.

### BACKGROUND

### 1. Technical Field

The present disclosure relates to a control device for a vehicle including an engine, a motor, and a clutch that can couple and decouple the engine and the motor to and from each other.

### 2. Description of Related Art

There is well known a control device for a vehicle including an engine, a motor coupled to a power transmission path between the engine and drive wheels so as to be able to transmit power, and a clutch which is provided between the engine and the motor in the power transmission path and the control state of which is switchable by controlling a clutch actuator. Japanese Unexamined Patent Application Publication No. 2018-122814 (JP 2018-122814 A) describes an example of such a control device for a vehicle. JP 2018-122814 A discloses that the engine is started by cranking the engine by controlling the clutch actuator so as to switch the control state of the clutch from a disengaged state to an engaged state and controlling the motor such that the motor outputs torque that has been increased by an amount for increasing the rotational speed of the engine in accordance with the control state of the clutch, and controlling the engine so as to start combustion by performing starting control such as fuel injection and plug ignition when the engine rotational speed reaches a rotational speed that enables initial combustion.

### SUMMARY

When the motor is to be controlled in accordance with the control state of the clutch when starting the engine, as indicated in JP 2018-122814 A, control is performed so as only to match the timing when the clutch is actually engaged to be able to transmit torque and the timing to increase output torque of the motor. Therefore, there is room for improving the precision in control during starting of the engine, by appropriately defining the control state of the clutch. When the definition of the control state of the clutch is divided into too fine divisions, however, the control during starting of the engine may be complicated. When the control during starting of the engine is complicated, the number of man-hours for development may be increased.

The present disclosure has been made with the foregoing circumstances as the background, and therefore has an object to provide a vehicle control device that can both improve the precision in control during starting of an engine and simplify the control.

A first aspect of the present disclosure relates to a control device for a vehicle including an engine, a motor coupled to a power transmission path between the engine and drive wheels so as to be able to transmit power, and a clutch that is provided between the engine and the motor in the power transmission path and a control state of which is switchable by controlling a clutch actuator. The control device includes an electronic control unit configured to: control the clutch actuator so as to switch the control state of the clutch from a disengaged state to an engaged state, when starting the engine; control the motor such that the motor outputs torque for increasing a rotational speed of the engine and control the engine such that the engine starts operation, when starting the engine; control the clutch actuator based on first phase definition that defines a plurality of stages of progress provided for each of control states of the clutch, the clutch being switched among the control states in a process of starting the engine; and control at least one of the motor and the engine based on second phase definition that defines a plurality of stages of progress, the second phase definition being different from the first phase definition.

According to the above aspect, the clutch actuator is controlled such that the control state of the clutch is switched from the disengaged state to the engaged state based on first phase definition in which a plurality of stages of progress provided for control states of the clutch among which switching is made in a process of starting the engine is defined for control of the clutch actuator, and the motor is controlled such that the motor outputs torque for increasing the rotational speed of the engine, and the engine is controlled such that the engine starts operation, based on second phase definition in which the plurality of stages of progress is defined for control of the motor and the engine. Thus, the clutch actuator and the motor and the engine can be separately controlled appropriately in accordance with the control state of the clutch. Hence, it is possible to both improve the precision in control during starting of the engine and simplify the control.

In the above aspect, the control state of the clutch may be divided into finer divisions in the first phase definition than in the second phase definition. In the above aspect, the number of the stages of progress defined by the first phase definition may be larger than the number of the stages of progress defined by the second phase definition. In the above aspect, at least one of the stages of progress defined by the second phase definition may correspond to two or more stages of progress defined by the first phase definition.

According to the above aspect, the control state of the clutch is divided into finer divisions in the first phase definition than in the second phase definition. Thus, it is possible to improve the precision in control for the clutch actuator, and hence improve the precision in control for the clutch, without complicating control for the motor and the engine, when starting the engine.

In the above aspect, the first phase definition may include a plurality of stages of progress including a rotation synchronization initial period, a rotation synchronization middle period, and a rotation synchronization final period defined based on the control state of the clutch in a rotation synchronization process for the motor and the engine. The second phase definition may include a stage of progress corresponding to a period constituted by at least integrating the rotation synchronization initial period, the rotation synchronization middle period, and the rotation synchronization final period.

According to the above aspect, the first phase definition has a plurality of stages of progress including a rotation synchronization initial period, a rotation synchronization middle period, and a rotation synchronization final period defined based on the control state of the clutch in a rotation synchronization process for the motor and the engine, and the second phase definition has a stage of progress constituted by integrating the rotation synchronization initial period, the rotation synchronization middle period, and the rotation synchronization final period, which are defined based on the control state of the clutch in the rotation synchronization process. Thus, it is possible to improve the precision in control for the clutch actuator, and hence improve the precision in control for the clutch, without complicating control for the motor and the engine, in the rotation synchronization process for the motor and the engine when starting the engine.

In the above aspect, the first phase definition may include a plurality of first stages of progress, timing of transition between the first stages of progress being defined based on timing of change in at least one of a requested hydraulic pressure of the clutch and a requested torque of the clutch. The second phase definition may include a plurality of second stages of progress, timing of transition between the second stages of progress being defined based on any one of timing of change in the requested torque of the clutch, whether a control for the clutch is started or not, and whether a difference between a rotational speed of the engine and a rotational speed of the motor satisfies a prescribed condition.

In the above aspect, the first phase definition may be defined based on a control request for switching the control state of the clutch. The second phase definition may be defined based on the control state of the clutch at a time when a control for the clutch is executed.

According to the above aspect, the clutch actuator can be controlled appropriately in accordance with the control state of the clutch which is desired to be controlled by using the first phase definition, and the motor and the engine can be controlled appropriately in accordance with the actual control state of the clutch by using the second phase definition.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 illustrates a schematic configuration of a vehicle to which the present disclosure is applied, illustrating an essential portion of the control function and the control system for various types of control for the vehicle;

FIG. 2 is a partial sectional view illustrating an example of a K0 clutch;

FIG. 3 is a table indicating various phases in phase definition for internal control;

FIG. 4 is a table indicating various phases in phase definition for external disclosure;

FIG. 5 is a flowchart illustrating an essential portion of control operation of an electronic control unit, illustrating control operation for both improving the precision in control during starting of an engine and simplifying the control

FIG. 6A illustrates an example of a time chart for a case where the control operation illustrated in the flowchart in FIG. 5 is executed; and

FIG. 6B illustrates an example of a time chart for a case where the control operation illustrated in the flowchart in FIG. 5 is executed.

### DETAILED DESCRIPTION OF EMBODIMENTS

An embodiment of the present disclosure will be described in detail below with reference to the drawings.

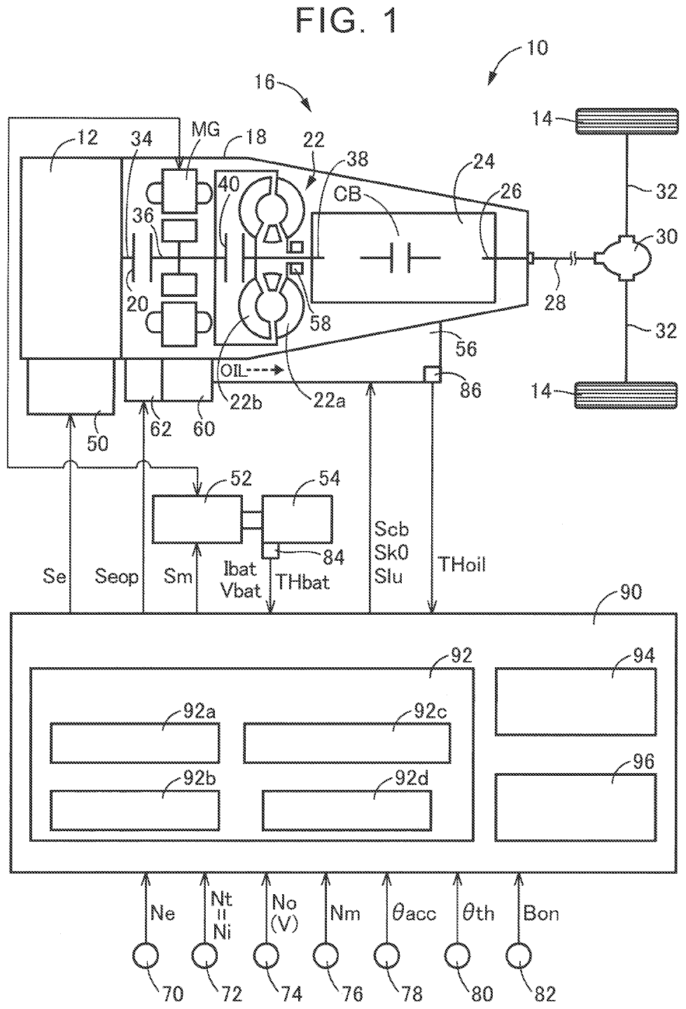

FIG. 1 illustrates a schematic configuration of a vehicle 10 to which the present disclosure is applied, illustrating an essential portion of the control function and the control system for various types of control for the vehicle 10. In FIG. 1, the vehicle 10 is a hybrid vehicle including an engine 12 and a motor MG which are drive force sources for travel. The vehicle 10 also includes drive wheels 14 and a power transmission device 16 provided in a power transmission path between the engine 12 and the drive wheels 14.

The engine 12 is a known internal combustion engine such as a gasoline engine and a diesel engine. Engine torque Te, which is output torque of the engine 12, is controlled by an electronic control unit 90, to be discussed later, controlling an engine control device 50, which includes a throttle actuator, a fuel injection device, an ignition device, etc. provided in the vehicle 10.

The motor MG is a rotary electric machine that has a function as an electric motor that generates mechanical power from electric power and a function as an electric generator that generates electric power from mechanical power, and is a so-called motor/generator (known as “MG” for short). Therefore, in the present application, “MG” is not only used as a reference sign of the motor, and the motor is also referred to as “MG” in terms such as “MG torque”. The motor MG is connected to a battery 54 provided in the vehicle 10 via an inverter 52 provided in the vehicle 10. MG torque Tm, which is output torque of the motor MG, is controlled by the electronic control unit 90, to be discussed later, controlling the inverter 52. When the rotational direction of the motor MG is positive, that is, the same rotational direction as during operation of the engine 12, for example, the MG torque Tm is power-running torque when the torque is positive on the acceleration side, and regeneration torque when the torque is negative on the deceleration side. Specifically, the motor MG generates power for travel using electric power supplied from the battery 54 via the inverter 52, in place of or in addition to the engine 12. The motor MG also generates electric power using power of the engine 12 or a driven force input from the side of the drive wheels 14. The electric power generated by the motor MG is accumulated in the battery 54 via the inverter 52. The battery 54 is a power accumulation device that exchanges electric power with the motor MG. The “electric power” is a synonym for “electric energy” unless specifically differentiated. The “power” is a synonym for “torque” and a “force” unless specifically differentiated.

The power transmission device 16 includes a K0 clutch 20, a torque converter 22, an automatic transmission 24, etc. provided in a case 18 which is a non-rotary member attached to the vehicle body. The K0 clutch 20 is a clutch provided between the engine 12 and the motor MG in the power transmission path between the engine 12 and the drive wheels 14. The torque converter 22 is coupled to the engine 12 via the K0 clutch 20. The automatic transmission 24 is coupled to the torque converter 22, and interposed in a power transmission path between the torque converter 22 and the drive wheels 14. Each of the torque converter 22 and the automatic transmission 24 constitutes a part of the power transmission path between the engine 12 and the drive wheels 14. The power transmission device 16 also includes a propeller shaft 28 coupled to a transmission output shaft 26 which is an output rotary member of the automatic transmission 24, a differential gear 30 coupled to the propeller shaft 28, a pair of drive shafts 32 coupled to the differential gear 30, etc. The power transmission device 16 also includes an engine coupling shaft 34 that couples the engine 12 and the K0 clutch 20 to each other, a motor coupling shaft 36 that couples the K0 clutch 20 and the torque converter 22 to each other, etc.

The motor MG is coupled to the motor coupling shaft 36 so as to be able to transmit power in the case 18. The motor MG is coupled to the power transmission path between the engine 12 and the drive wheels 14, particularly a power transmission path between the K0 clutch 20 and the torque converter 22, so as to be able to transmit power. That is, the motor MG is coupled to the torque converter 22 and the automatic transmission 24, not via the K0 clutch 20, so as to be able to transmit power. When seen from a different point of view, each of the torque converter 22 and the automatic transmission 24 constitutes a part of a power transmission path between the motor MG and the drive wheels 14. Each of the torque converter 22 and the automatic transmission 24 transmits a drive force from each of the drive force sources, namely the engine 12 and the motor MG, to the drive wheels 14.

The torque converter 22 includes a pump vane wheel 22a coupled to the motor coupling shaft 36 and a turbine vane wheel 22b coupled to a transmission input shaft 38 which is an input rotary member of the automatic transmission 24. The pump vane wheel 22a is coupled to the engine 12 via the K0 clutch 20, and directly coupled to the motor MG. The pump vane wheel 22a is an input member of the torque converter 22. The turbine vane wheel 22b is an output member of the torque converter 22. The motor coupling shaft 36 also serves as an input rotary member of the torque converter 22. The transmission input shaft 38 also serves as an output rotary member of the torque converter 22 which is formed integrally with a turbine shaft rotationally driven by the turbine vane wheel 22b. The torque converter 22 is a hydraulic power transmission device that transmits a drive force from each of the drive force sources (the engine 12 and the motor MG) to the transmission input shaft 38 via a fluid. The torque converter 22 includes an LU clutch 40 that couples the pump vane wheel 22a and the turbine vane wheel 22b to each other. The LU clutch 40 is a direct clutch that couples the input and output rotary members of the torque converter 22 to each other, that is, a known lock-up clutch.

The operation state, that is, the control state, of the LU clutch 40 is switched by varying LU clutch torque Tlu, which is the torque capacity of the LU clutch 40, in accordance with an LU hydraulic pressure PRlu adjusted by and supplied from a hydraulic control circuit 56 provided in the vehicle 10. The control state of the LU clutch 40 includes a completely disengaged state in which the LU clutch 40 is disengaged, a slip state in which the LU clutch 40 is engaged with slipping, and a completely engaged state in which the LU clutch 40 is engaged. When the LU clutch 40 is in the completely disengaged state, the torque converter 22 is in a torque converter state in which the torque amplification function can be obtained. When the LU clutch 40 is in the completely engaged state, meanwhile, the torque converter 22 is in a lock-up state in which the pump vane wheel 22a and the turbine vane wheel 22b are rotated together.

The automatic transmission 24 is a known automatic transmission of a planetary gear type, which includes one or more sets of planetary gear devices (not illustrated) and a plurality of engagement devices CB, for example. The engagement devices CB are hydraulic friction engagement devices composed of a clutch and a brake of a multi-plate or single-plate type pressed by a hydraulic actuator, a band brake tightened by a hydraulic actuator, etc., for example. The control state, such as an engaged state and a disengaged state, of each of the engagement devices CB is switched by varying CB torque Tcb, which is the torque capacity of each engagement device CB, in accordance with a CB hydraulic pressure PRcb adjusted by and supplied from the hydraulic control circuit 56.

The automatic transmission 24 is a stepped transmission in which any one of a plurality of shift gears (also referred to as “gear stages”) with different speed ratios (also referred to as “gear ratios”) γ at (=AT input rotational speed Ni/AT output rotational speed No) is established by engaging any of the engagement devices CB. In the automatic transmission 24, the gear stage to be established is switched, that is, a plurality of gear stages is selectively established, in accordance with an accelerator operation by a driver, a vehicle speed V, etc., by the electronic control unit 90 to be discussed later. The AT input rotational speed Ni is the rotational speed of the transmission input shaft 38, and an input rotational speed of the automatic transmission 24. The AT input rotational speed Ni is also the rotational speed of the output rotary member of the torque converter 22, and is equal to a turbine rotational speed Nt which is an output rotational speed of the torque converter 22. The AT input rotational speed Ni can be represented using the turbine rotational speed Nt. The AT output rotational speed No is the rotational speed of the transmission output shaft 26, and an output rotational speed of the automatic transmission 24.

The K0 clutch 20 is a friction engagement device of a wet or dry type, which is constituted of a multi-plate or single-plate clutch pressed by a clutch actuator 120 to be discussed later, for example. The control state, such as an engaged state and a disengaged state, of the K0 clutch 20 is switched by the electronic control unit 90, to be discussed later, controlling the clutch actuator 120.

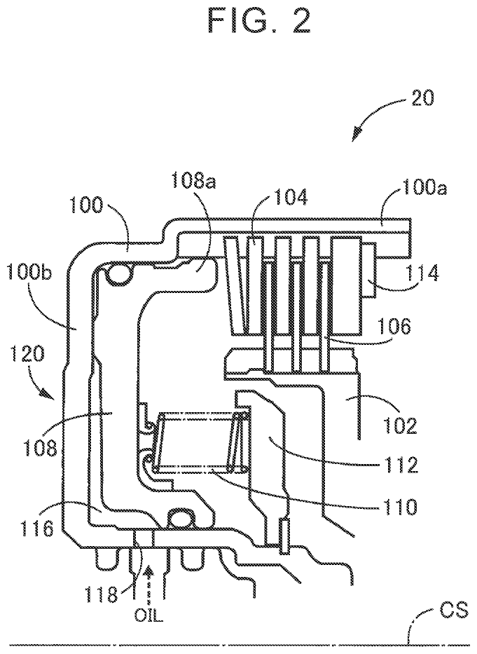

FIG. 2 is a partial sectional view illustrating an example of the K0 clutch 20. In FIG. 2, the K0 clutch 20 includes a clutch drum 100, a clutch hub 102, separation plates 104, friction plates 106, a piston 108, a return spring 110, a spring receiving plate 112, and a snap ring 114. The clutch drum 100 and the clutch hub 102 are provided on an identical axis CS. FIG. 2 illustrates the radially outer peripheral portion of the K0 clutch 20 above the axis CS. The axis CS is the axis of the engine coupling shaft 34, the motor coupling shaft 36, etc. The clutch drum 100 is coupled to the engine coupling shaft 34, for example, and rotated together with the engine coupling shaft 34. The clutch hub 102 is coupled to the motor coupling shaft 36, for example, and rotated together with the motor coupling shaft 36. The separation plates 104 are spline-fitted, that is, the outer peripheral edges of a plurality of separation plates 104 in a generally annular plate shape are fitted with the inner peripheral surface of a tubular portion 100a of the clutch drum 100 so as not to be relatively rotatable. The friction plates 106 are interposed between the plurality of separation plates 104, and spline-fitted, that is, the inner peripheral edges of a plurality of friction plates 106 in a generally annular plate shape are fitted with the outer peripheral surface of the clutch hub 102 so as not to be relatively rotatable. A pressing portion 108a that extends in the direction of the separation plates 104 and the friction plates 106 is provided at the outer peripheral edge of the piston 108. The return spring 110 is interposed between the piston 108 and the spring receiving plate 112, and biases a part of the piston 108 so as to abut against a bottom plate portion 100b of the clutch drum 100. That is, the return spring 110 functions as a spring element that biases the piston 108 such that the separation plates 104 and the friction plates 106 are brought toward the disengagement side. The snap ring 114 is fixed to the tubular portion 100a of the clutch drum 100 at a position at which the separation plates 104 and the friction plates 106 are interposed between the pressing portion 108a of the piston 108 and the snap ring 114. An oil chamber 116 is formed in the K0 clutch 20 between the piston 108 and the bottom plate portion 100b of the clutch drum 100. An oil path 118 that leads to the oil chamber 116 is formed in the clutch drum 100. In the K0 clutch 20, the clutch actuator 120 as a hydraulic actuator is composed of the clutch drum 100, the piston 108, the return spring 110, the spring receiving plate 112, the oil chamber 116, etc.

In the thus configured K0 clutch 20, when a K0 hydraulic pressure PRk0 adjusted by and supplied from the hydraulic control circuit 56 is supplied to the oil chamber 116 through the oil path 118, the piston 108 is moved by the K0 hydraulic pressure PRk0 in the direction of the separation plates 104 and the friction plates 106 against the biasing force of the return spring 110, and the pressing portion 108a of the piston 108 presses the separation plates 104 and the friction plates 106. When the separation plates 104 and the friction plates 106 are pressed, the K0 clutch 20 is switched to the engaged state. The control state of the K0 clutch 20 is switched when K0 torque Tk0 which is the torque capacity of the K0 torque 20 is varied by the K0 hydraulic pressure PRk0.

The K0 torque Tk0 is determined in accordance with the friction coefficient of the friction material of the friction plates 106, the K0 hydraulic pressure PRk0, etc., for example. In the K0 clutch 20, so-called “packing” is completed when the oil chamber 116 is filled with hydraulic oil OIL and the clearance between the separation plates 104 and the friction plates 106 is filled by a pushing force (=PRk0×piston pressure receiving area) of the piston 108 which resists the biasing force of the return spring 110. The K0 clutch 20 generates the K0 torque Tk0 when the K0 hydraulic pressure PRk0 is further increased from the state in which the packing is completed. That is, the torque capacity of the K0 clutch 20 starts increasing when the K0 hydraulic pressure PRk0 is increased from the state in which the packing of the K0 clutch 20 is completed. The K0 hydraulic pressure PRk0 for packing of the K0 clutch 20 is the K0 hydraulic pressure PRk0 for establishing a state in which the piston 108 has reached a stroke end and the K0 torque Tk0 is not generated.

Returning to FIG. 1, when the K0 clutch 20 is in the engaged state, the pump vane wheel 22a and the engine 12 are rotated together via the engine coupling shaft 34. That is, the K0 clutch 20 is engaged to couple the engine 12 and the drive wheels 14 to each other so as to be able to transmit power. When the K0 clutch 20 is in the disengaged state, on the other hand, power transmission between the engine 12 and the pump vane wheel 22a is blocked. That is, the K0 clutch 20 is disengaged to decouple the engine 12 and the drive wheels 14 from each other. The motor MG is coupled to the pump vane wheel 22a. Thus, the K0 clutch 20 is provided in the power transmission path between the engine 12 and the motor MG to function as a clutch that connects and disconnects the power transmission path, that is, a clutch that connects and disconnects the engine 12 and the motor MG. That is, the K0 clutch 20 is a clutch for connection and disconnection that is engaged to couple the engine 12 and the motor MG to each other and disengaged to decouple the engine 12 and the motor MG from each other.

In the power transmission device 16, power output from the engine 12 is transmitted from the engine coupling shaft 34 to the drive wheels 14 sequentially via the K0 clutch 20, the motor coupling shaft 36, the torque converter 22, the automatic transmission 24, the propeller shaft 28, the differential gear 30, the drive shafts 32, etc. when the K0 clutch 20 is engaged. Meanwhile, power output from the motor MG is transmitted from the motor coupling shaft 36 to the drive wheels 14 sequentially via the torque converter 22, the automatic transmission 24, the propeller shaft 28, the differential gear 30, the drive shafts 32, etc., irrespective of the control state of the K0 clutch 20.

The vehicle 10 includes an MOP 58 which is a mechanical oil pump, an EOP 60 which is an electric oil pump, a pump motor 62, etc. The MOP 58 is coupled to the pump vane wheel 22a, and rotationally driven by the drive force sources (the engine 12 and the motor MG) to discharge the hydraulic oil OIL to be used in the power transmission device 16. The pump motor 62 is a motor exclusively for the EOP 60 for rotationally driving the EOP 60. The EOP 60 is rotationally driven by the pump motor 62 to discharge the hydraulic oil OIL. The hydraulic oil OIL discharged by the MOP 58 and the EOP 60 is supplied to the hydraulic control circuit 56. The hydraulic control circuit 56 supplies the CB hydraulic pressure PRcb, the K0 hydraulic pressure PRk0, the LU hydraulic pressure PR1u, etc. which are adjusted based on the hydraulic oil OIL discharged by the MOP 58 and/or the EOP 60.

The vehicle 10 further includes the electronic control unit 90 which includes a control device for the vehicle 10 associated with starting control etc. for the engine 12. The electronic control unit 90 is configured to include a so-called microcomputer that includes a central processing unit (CPU), a random access memory (RAM), a read only memory (ROM), an input/output interface, etc., for example. The CPU executes various types of control for the vehicle 10 by performing signal processing in accordance with a program stored in advance in the ROM while utilizing a temporary storage function of the RAM. The electronic control unit 90 is configured to include computers for engine control, motor control, hydraulic control, etc. as necessary.

The electronic control unit 90 is supplied with various signals (e.g. an engine rotational speed Ne which is the rotational speed of the engine 12, the turbine rotational speed Nt which is equal to the AT input rotational speed Ni, the AT output rotational speed No corresponding to the vehicle speed V, an MG rotational speed Nm which is the rotational speed of the motor MG, an accelerator operation amount θacc which is the amount of an accelerator operation by the driver which represents the magnitude of an acceleration operation by the driver, a throttle valve opening degree θth which is the opening degree of an electronic throttle valve, a brake on signal Bon which is a signal that indicates a state in which a brake pedal for actuating wheel brakes is operated by the driver, a battery temperature THbat, a battery charge/discharge current Ibat, and a battery voltage Vbat of the battery 54, a hydraulic oil temperature THoil which is the temperature of the hydraulic oil OIL in the hydraulic control circuit 56, etc.) which are based on detection values from various sensors (e.g. an engine rotational speed sensor 70, a turbine rotational speed sensor 72, an output rotational speed sensor 74, an MG rotational speed sensor 76, an accelerator operation amount sensor 78, a throttle valve opening degree sensor 80, a brake switch 82, a battery sensor 84, an oil temperature sensor 86, etc.) provided in the vehicle 10.

The electronic control unit 90 outputs various command signals (e.g. an engine control command signal Se for controlling the engine 12, an MG control command signal Sm for controlling the motor MG, a CB hydraulic pressure control command signal Scb for controlling the engagement devices CB, a K0 hydraulic pressure control command signal Sk0 for controlling the K0 clutch 20, an LU hydraulic pressure control command signal Slu for controlling the LU clutch 40, an EOP control command signal Seop for controlling the EOP 60, etc.) to various devices (e.g. the engine control device 50, the inverter 52, the hydraulic control circuit 56, the pump motor 62, etc.) provided in the vehicle 10.

In order to implement various types of control in the vehicle 10, the electronic control unit 90 includes a hybrid control unit 92 as hybrid control means, a clutch control unit 94 as clutch control means, and a shift control unit 96 as shift control means.

The hybrid control unit 92 includes a function as an engine control unit 92a as engine control means for controlling operation of the engine 12 and a function as a motor control unit 92b as motor control means for controlling operation of the motor MG via the inverter 52, and executes hybrid drive control etc. with the engine 12 and the motor MG through such control functions.

The hybrid control unit 92 calculates a requested drive amount requested for the vehicle 10 by the driver, by applying the accelerator operation amount eacc and the vehicle speed V to a requested drive amount map, for example. The requested drive amount map defines a relationship obtained experimentally or through design in advance, that is, a relation determined in advance. The requested drive amount is requested drive torque Trdem for the drive wheels 14, for example. When seen from a different point of view, the requested drive torque Trdem [Nm] is requested drive power Prdem [W] at the vehicle speed V at that time. A requested drive force Frdem [N] for the drive wheels 14, requested AT output torque for the transmission output shaft 26, etc. can also be used as the requested drive amount. The requested drive amount may be calculated using the AT output rotational speed No etc. in place of the vehicle speed V.

The hybrid control unit 92 outputs the engine control command signal Se for controlling the engine 12 and the MG control command signal Sm for controlling the motor MG so as to achieve the requested drive power Prdem in consideration of the transmission loss, the accessory load, the speed ratio yat of the automatic transmission 24, chargeable power Win and dischargeable power Wout of the battery 54, etc. The engine control command signal Se is a command value for engine power Pe which is power of the engine 12 which outputs engine torque Te at the engine rotational speed Ne at that time, for example. The MG control command signal Sm is a command value for power consumption Wm of the motor MG which outputs the MG torque Tm at the MG rotational speed Nm at that time, for example.

The chargeable power Win of the battery 54 is maximum power that can be input and that prescribes limitation on power input to the battery 54, and indicates limitation on input to the battery 54. The dischargeable power Wout of the battery 54 is maximum power that can be output and that prescribes limitation on power output from the battery 54, and indicates limitation on output from the battery 54. The chargeable power Win and the dischargeable power Wout of the battery 54 are calculated by the electronic control unit 90 based on the battery temperature THbat and a charge state value SOC [%] of the battery 54, for example. The charge state value SOC of the battery 54 is a value that indicates the charge state of the battery 54, and is calculated by the electronic control unit 90 based on the battery charge/discharge current Ibat and the battery voltage Vbat, for example.

When the requested drive torque Trdem can be covered using only output of the motor MG, the hybrid control unit 92 sets the travel mode to a motor travel (=EV travel) mode. In the EV travel mode, the hybrid control unit 92 performs EV travel in which the vehicle travels using only the motor MG as a drive force source with the K0 clutch 20 in the disengaged state. When the requested drive torque Trdem cannot be covered without using at least output of the engine 12, meanwhile, the hybrid control unit 92 sets the travel mode to an engine travel mode, that is, a hybrid travel (=HV travel) mode. In the HV travel mode, the hybrid control unit 92 performs engine travel, that is, HV travel, in which the vehicle travels using at least the engine 12 as a drive force source with the K0 clutch 20 in the engaged state. On the other hand, the hybrid control unit 92 establishes the HV travel mode when the charge state value SOC of the battery 54 is less than an engine start threshold determined in advance, the engine 12 etc. needs warming up, etc., even if the requested drive torque Trdem can be covered using only output of the motor MG. The engine start threshold is a threshold determined in advance for determining that the charge state value SOC requires charging the battery 54 by forcibly starting the engine 12. In this manner, the hybrid control unit 92 switches between the EV travel mode and the HV travel mode by automatically stopping the engine 12 during EV travel, restarting the engine 12 after the engine stop, and starting the engine 12 during EV travel based on the requested drive torque Trdem etc.

The hybrid control unit 92 further includes a function as an engine start determination unit 92c, that is, engine start determination means, and a function as a start control unit 92d, that is, start control means.

The engine start determination unit 92c determines the presence or absence of a start request for the engine 12. For example, the engine start determination unit 92c determines whether there is a start request for the engine 12 during the EV travel mode based on whether the requested drive torque Trdem is increased beyond a range in which the requested drive torque Trdem can be covered using only output of the motor MG, whether the engine 12 etc. needs warming up, whether the charge state value SOC of the battery 54 is less than the engine start threshold, etc. The engine start determination unit 92c also determines whether starting control for the engine 12 is completed.

The clutch control unit 94 controls the K0 clutch 20 so as to execute starting control for the engine 12. For example, when the engine start determination unit 92c determines that there is a start request for the engine 12, the clutch control unit 94 outputs, to the hydraulic control circuit 56, the K0 hydraulic pressure control command signal Sk0 for controlling the K0 clutch 20 in the disengaged state toward the engaged state, so as to obtain the K0 torque Tk0 for transmitting torque needed for cranking of the engine 12, which is torque for increasing the engine rotational speed Ne, to the side of the engine 12. That is, the clutch control unit 94 outputs, to the hydraulic control circuit 56, the K0 hydraulic pressure control command signal Sk0 for controlling the clutch actuator 120 so as to switch the control state of the K0 clutch 20 from the disengaged state to the engaged state, when starting the engine 12. In the present embodiment, torque needed for cranking of the engine 12 is referred to as “necessary cranking torque Tcrn”.

The start control unit 92d controls the engine 12 and the motor MG so as to execute starting control for the engine 12. For example, when the engine start determination unit 92c determines that there is a start request for the engine 12, the start control unit 92d outputs, to the inverter 52, the MG control command signal Sm for the motor MG to output the necessary cranking torque Tcrn in accordance with switching of the K0 clutch 20 to the engaged state by the clutch control unit 94. That is, the start control unit 92d outputs, to the inverter 52, the MG control command signal Sm for controlling the motor MG such that the motor MG outputs the necessary cranking torque Tcrn, when starting the engine 12.

When the engine start determination unit 92c determines that there is a start request for the engine 12, in addition, the start control unit 92d outputs, to the engine control device 50, the engine control command signal Se for starting fuel supply, engine ignition, etc. in conjunction with cranking of the engine 12 by the K0 clutch 20 and the motor MG. That is, the start control unit 92d outputs, to the engine control device 50, the engine control command signal Se for controlling the engine 12 such that the engine 12 starts operation, when starting the engine 12.

When cranking the engine 12, cranking reaction torque Trfcr which is reaction torque that accompanies engagement of the K0 clutch 20 is generated. The cranking reaction torque Trfcr causes a sense that the vehicle 10 is pulled by the inertia, that is, a drop in drive torque Tr, during starting of the engine during EV travel. Therefore, the necessary cranking torque Tcrn which is output from the motor MG when starting the engine 12 is also the MG torque Tm for canceling the cranking reaction torque Trfcr. That is, the necessary cranking torque Tcrn is the K0 torque Tk0 which is necessary for cranking of the engine 12, and corresponds to the MG torque Tm which flows from the side of the motor MG to the side of the engine 12 via the K0 clutch 20. The necessary cranking torque Tcrn is cranking torque Tcr which is constant, for example, determined in advance based on the specifications etc. of the engine 12, for example.

When starting the engine 12 during EV travel, the start control unit 92d causes the motor MG to output the MG torque Tm in an amount corresponding to the necessary cranking torque Tcrn, in addition to the MG torque Tm for EV travel, that is, the MG torque Tm for generating the drive torque Tr. Therefore, it is necessary to secure the MG torque Tm in the amount corresponding to the necessary cranking torque Tcrn, in preparation to start the engine 12, during EV travel. Thus, the range in which the requested drive torque Trdem can be covered using only output of the motor MG is the range of torque obtained by subtracting the MG torque Tm in the amount corresponding to the necessary cranking torque Tcrn from maximum torque of the motor MG that can be output. The maximum torque of the motor MG that can be output is the maximum MG torque Tm that can be output using the dischargeable power Wout of the battery 54.

The shift control unit 96 determines shifting of the automatic transmission 24 using a shift map that defines a relationship determined in advance, for example, and outputs, to the hydraulic control circuit 56, the CB hydraulic pressure control command signal Scb for executing shift control for the automatic transmission 24 as necessary. The shift map defines a predetermined relationship having a shift line for determining shift of the automatic transmission 24 on two-dimensional coordinates defined using the vehicle speed V and the requested drive torque Trdem as variables, for example. In the shift map, the AT output rotational speed No etc. may be used in place of the vehicle speed V, and the requested drive force Frdem, the accelerator operation amount eacc, the throttle valve opening degree eth, etc. may be used in place of the requested drive torque Trdem.

In order for the control state of the K0 clutch 20 to be controlled precisely when starting the engine 12, a plurality of stages of progress, that is, phases, provided for each control state of the K0 clutch 20 among which switching is made in the process of starting the engine 12 is determined in advance in the electronic control unit 90 as phase definition for internal control Dphin, or first phase definition, defined for control of the clutch actuator 120.

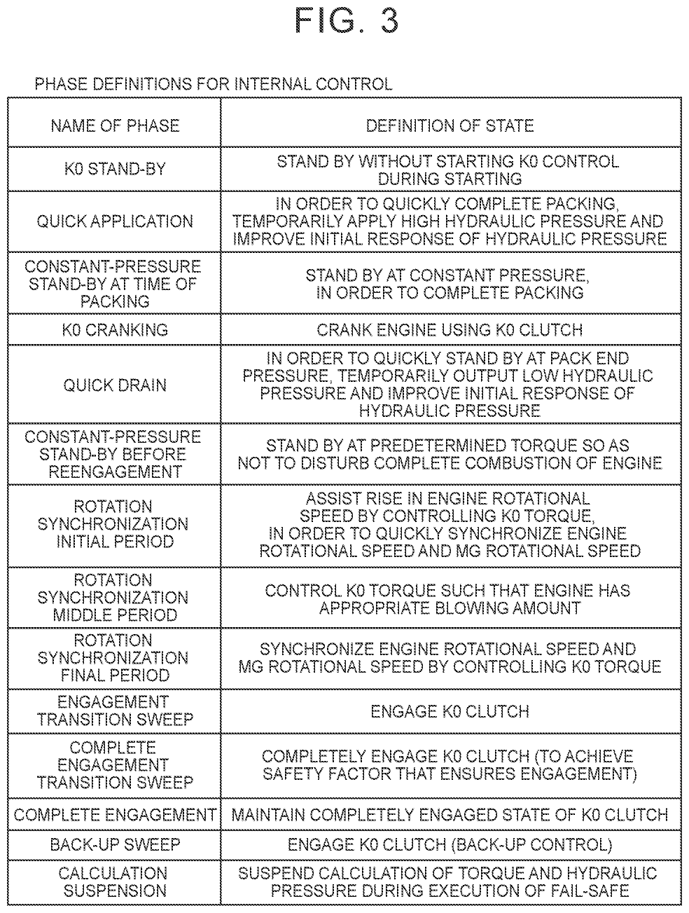

FIG. 3 is a table indicating various phases in the phase definition for internal control Dphin. In FIG. 3, the phase definition for internal control Dphin define phases such as “K0 stand-by”, “quick application”, “constant-pressure stand-by at time of packing”, “K0 cranking”, “quick drain”, “constant-pressure stand-by before reengagement”, “rotation synchronization initial period”, “rotation synchronization middle period”, “rotation synchronization final period”, “engagement transition sweep”, “complete engagement transition sweep”, “complete engagement”, “back-up sweep”, and “calculation suspension”.

A transition is made to the “K0 stand-by” phase when a K0 stand-by determination is made when starting control for the engine 12 is started. In the “K0 stand-by” phase, the control stands by without starting control for the K0 clutch 20 during starting control for the engine 12.

A transition is made to the “quick application” phase when a K0 stand-by determination is not made when starting control for the engine 12 is started. Alternatively, a transition is made to the “quick application” phase from the “K0 stand-by” phase when a K0 stand-by determination is withdrawn while standing by to start control for the K0 clutch 20. In the “quick application” phase, in order for packing of the K0 clutch 20 to be completed quickly, quick application in which a command value for a high K0 hydraulic pressure PRk0 is temporarily applied is executed and the initial response of the K0 hydraulic pressure PRk0 is improved. The command value for the K0 hydraulic pressure PRk0 is the K0 hydraulic pressure control command signal Sk0 for a solenoid valve for the K0 clutch 20 in the hydraulic control circuit 56, which outputs the adjusted K0 hydraulic pressure PRk0.

A transition is made to the “constant-pressure stand-by at time of packing” phase from the “quick application” phase when quick application is completed. In the “constant-pressure stand-by at time of packing” phase, the control stands by at a constant pressure, in order for clearance filling of the K0 clutch 20 to be completed.

A transition is made to the “K0 cranking” phase from the “constant-pressure stand-by at time of packing” phase when clearance filling of the K0 clutch 20 is completed. In the “K0 cranking” phase, cranking of the engine 12 is performed by the K0 clutch 20.

A transition is made to the “quick drain” phase from the “K0 cranking” phase when cranking of the engine 12 is completed and a quick drain execution determination is made. In the “quick drain” phase, in order that the control can quickly stand by at a predetermined K0 hydraulic pressure PRk0, e.g. a pack end pressure, in the next, “constant-pressure stand-by before reengagement” phase, quick drain in which a command value for a low K0 hydraulic pressure PRk0 is temporarily output is executed and the initial response of the K0 hydraulic pressure PRk0 is improved.

A transition is made to the “constant-pressure stand-by before reengagement” phase from the “K0 cranking” phase when cranking of the engine 12 is completed and a quick drain execution determination is not made. Alternatively, a transition is made to the “constant-pressure stand-by before reengagement” phase from the “quick drain” phase when quick drain is completed. In the “constant-pressure stand-by before reengagement” phase, the control stands by at predetermined K0 torque Tk0 so as not to disturb complete combustion of the engine 12. Complete combustion of the engine 12 is a state in which the engine 12 is rotating stably in a self-sustained manner because of combustion of the engine 12 after initial combustion at which ignition of the engine 12 is started, for example. When complete combustion of the engine 12 is not disturbed, it is meant that self-sustained rotation of the engine 12 is not disturbed.

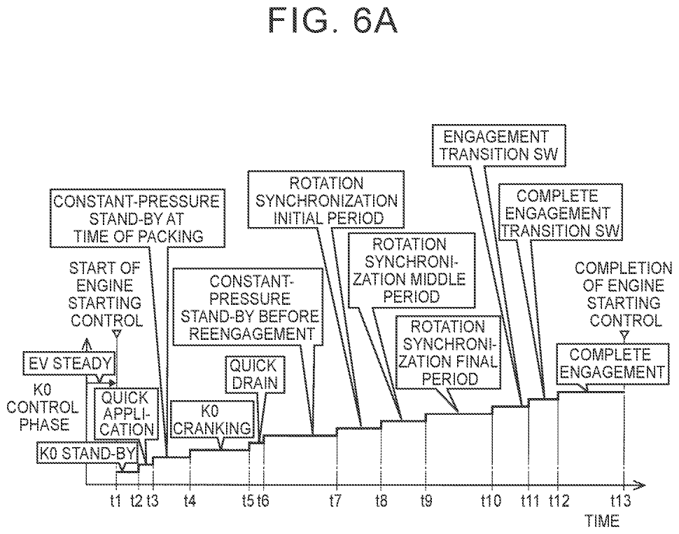

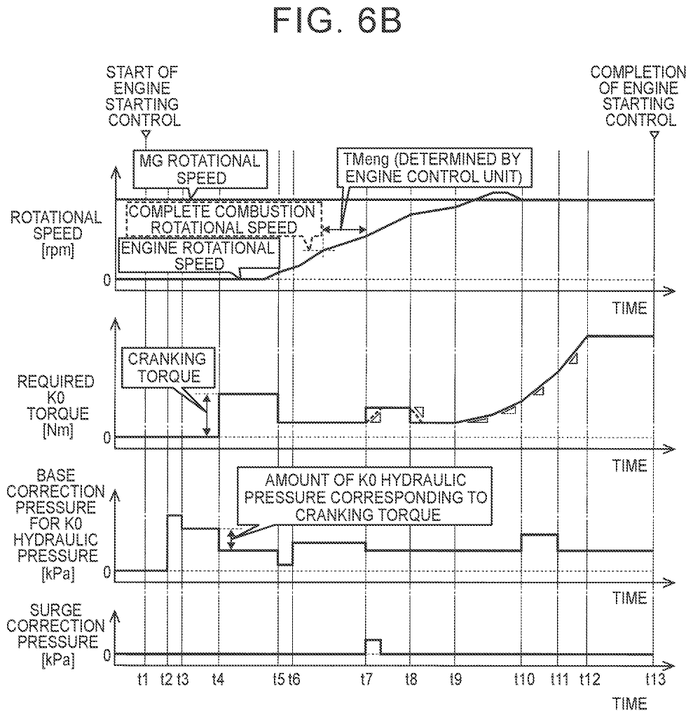

A transition is made to the “rotation synchronization initial period” phase from the “constant-pressure stand-by before reengagement” phase when neither a condition for a transition to the “rotation synchronization final period” phase nor a condition for a transition to the “rotation synchronization middle period” phase is met when a notification of complete combustion is received from the engine control unit 92a. The condition for a transition to the “rotation synchronization final period” phase is a condition that a K0 rotation difference ΔNk0 is equal to or less than a rotation synchronization final period transition determination rotation difference determined in advance. The K0 rotation difference ΔNk0 is the difference (=Nm−Ne, that is, difference between the engine rotational speed Ne and the MG rotational speed Nm) in the rotational speed of the K0 clutch 20. The condition for a transition to the “rotation synchronization middle period” phase is a condition that the condition for a transition to the “rotation synchronization final period” phase is not met and the K0 rotation difference ΔNk0 is equal to or less than a rotation synchronization middle period transition determination rotation difference determined in advance. The rotation synchronization middle period transition determination rotation difference is larger than the rotation synchronization final period transition determination rotation difference. In the “rotation synchronization initial period” phase, a rise in the engine rotational speed Ne is assisted by controlling the K0 torque Tk0, in order to quickly synchronize the engine rotational speed Ne and the MG rotational speed Nm with each other. The engine control unit 92a outputs a notification of complete combustion of the engine 12 when the elapsed time since the time when the engine rotational speed Ne has reached a complete combustion rotational speed of the engine 12 determined in advance exceeds a complete combustion notification stand-by time TMeng determined in advance (see FIG. 6B to be discussed later), for example. The complete combustion notification stand-by time TMeng is determined in advance in consideration of an exhaust gas requirement for the engine 12, for example.

A transition is made to the “rotation synchronization middle period” phase from the “constant-pressure stand-by before reengagement” phase when the condition for a transition to the “rotation synchronization middle period” phase is met when a notification of complete combustion is received from the engine control unit 92a. Alternatively, a transition is made to the “rotation synchronization middle period” phase from the “rotation synchronization initial period” phase when the condition for a transition to the “rotation synchronization middle period” phase is met during execution of the “rotation synchronization initial period” phase. In the “rotation synchronization middle period” phase, the K0 torque Tk0 is controlled such that the engine 12 has an appropriate blowing amount (=Ne−Nm).

A transition is made to the “rotation synchronization final period” phase from the “constant-pressure stand-by before reengagement” phase when the condition for a transition to the “rotation synchronization final period” phase is met when a notification of complete combustion is received from the engine control unit 92a. Alternatively, a transition is made to the “rotation synchronization final period” phase from the “rotation synchronization initial period” phase when the condition for a transition to the “rotation synchronization final period” phase is met during execution of the “rotation synchronization initial period” phase. Alternatively, a transition is made to the “rotation synchronization final period” phase from the “rotation synchronization middle period” phase when the condition for a transition to the “rotation synchronization final period” phase is met during execution of the “rotation synchronization middle period” phase. Alternatively, a transition is made to the “rotation synchronization final period” phase from the “rotation synchronization middle period” phase when shift control for the automatic transmission 24 is not performed and a state in which it is predicted that synchronization between the engine rotational speed Ne and the MG rotational speed Nm cannot be achieved is established continuously for a forcible rotation synchronization transition determination time or more during execution of the “rotation synchronization middle period” phase. Whether synchronization between the engine rotational speed Ne and the MG rotational speed Nm can be achieved is predicted based on the K0 rotation difference ΔNk0, the gradient of variation in the engine rotational speed Ne, and the gradient of variation in the MG rotational speed Nm, for example. In the “rotation synchronization final period” phase, the engine rotational speed Ne and the MG rotational speed Nm are synchronized with each other by controlling the K0 torque Tk0.

A transition is made to the “engagement transition sweep” phase from the “rotation synchronization final period” phase when a rotation synchronization determination is made during execution of the “rotation synchronization final period” phase. The rotation synchronization determination is made in accordance with whether a determination that the absolute value of the K0 rotation difference ΔNk0 is equal to or less than a rotation synchronization determination rotation difference determined in advance is made consecutively the rotation synchronization determination number of times determined in advance or more. In the “engagement transition sweep” phase, the K0 clutch 20 is brought into the engaged state by gradually increasing the K0 torque Tk0.

A transition is made to the “complete engagement transition sweep” phase from the “engagement transition sweep” phase when a K0 engagement determination is made during execution of the “engagement transition sweep” phase. The K0 engagement determination is made in accordance with whether a determination that the absolute value of the K0 rotation difference ΔNk0 is equal to or less than a complete engagement transition sweep determination rotation difference determined in advance is made consecutively the complete engagement transition sweep transition determination number of times determined in advance or more. Alternatively, a transition is made to the “complete engagement transition sweep” phase from the “engagement transition sweep” phase when a K0 rotation synchronization state cannot be maintained during execution of the “engagement transition sweep” phase. The K0 rotation synchronization state cannot be maintained when a determination that the absolute value of the K0 rotation difference ΔNk0 is more than a value obtained by adding a forcible engagement transition determination rotation difference determined in advance to the complete engagement transition sweep determination rotation difference is made consecutively the rotation separation complete engagement transition sweep transition determination number of times determined in advance or more. Alternatively, a transition is made to the “complete engagement transition sweep” phase from the “engagement transition sweep” phase when the elapsed time since the start of the “engagement transition sweep” phase is more than a forcible engagement transition determination time determined in advance and it is determined that the absolute value of the K0 rotation difference ΔNk0 is equal to or more than a complete engagement transition sweep forcible transition determination rotation difference determined in advance. In the “complete engagement transition sweep” phase, the K0 clutch 20 is brought into the completely engaged state by gradually increasing the K0 torque Tk0. When the K0 clutch 20 is brought into the completely engaged state, it is meant that the K0 torque Tk0 is increased to a state in which a safety factor that ensures engagement of the K0 clutch 20 is added, for example.

A transition is made to the “complete engagement” phase from the “complete engagement transition sweep” phase when a complete engagement determination is made during execution of the “complete engagement transition sweep” phase. The complete engagement determination is made in accordance with whether a determination that the K0 torque Tk0 is equal to or more than a value obtained by multiplying necessary K0 torque Tk0n by a safety factor (>1) determined in advance is made consecutively the complete synchronization determination number of times determined in advance or more. The necessary K0 torque Tk0n is the K0 torque Tk0 that is necessary for complete engagement of the K0 clutch 20, and is the largest value selected from the engine torque Te, the MG torque Tm, and minimum complete engagement ensuring torque, for example. The minimum complete engagement ensuring torque is the minimum K0 torque Tk0 that is necessary for complete engagement determined in advance. Alternatively, a transition is made to the “complete engagement” phase from the “complete engagement transition sweep” phase when the elapsed time since the start of the “complete engagement transition sweep” phase is equal to or more than a forcible complete engagement transition determination time determined in advance and it is determined that the absolute value of the K0 rotation difference ΔNk0 is equal to or more than a complete engagement forcible transition determination rotation difference determined in advance. In the “complete engagement” phase, the completely engaged state of the K0 clutch 20 is maintained.

A transition is made to the “complete engagement” phase also from the “back-up sweep” phase. A transition is made to the “complete engagement” phase from the “back-up sweep” phase when the complete engagement determination is made and a determination that the absolute value of the K0 rotation difference ΔNk0 is equal to or less than a back-up time rotation synchronization determination rotation difference determined in advance is made consecutively the back-up time rotation synchronization determination number of times determined in advance or more during execution of the “back-up sweep” phase. Alternatively, a transition is made to the “complete engagement” phase from the “back-up sweep” phase when the elapsed time since the transition to a phase other than the “K0 stand-by” phase after the start of starting control for the engine 12 is equal to or more than an engine starting control timeout time determined in advance and it is determined that the absolute value of the K0 rotation difference ΔNk0 is equal to or more than the complete engagement forcible transition determination rotation difference during execution of the “back-up sweep” phase.

A transition is made to the “back-up sweep” phase from the phase being executed when the elapsed time since the start of the phase being executed is more than a back-up transition determination time for the phase being executed, determined in advance, and it is determined that the K0 rotation difference ΔNk0 is equal to or more than a back-up transition determination rotation difference for the phase being executed, determined in advance, in order to suppress the control being stuck, during execution of any of the “K0 cranking” phase, the “constant-pressure stand-by before reengagement” phase, the “rotation synchronization initial period” phase, the “rotation synchronization middle period” phase, and the “rotation synchronization final period” phase. In the “back-up sweep” phase, back-up control in which the K0 clutch 20 is engaged by gradually increasing the K0 torque Tk0 is performed.

In the “calculation suspension” phase, calculation of a base correction pressure for the K0 hydraulic pressure PRk0 and requested K0 torque Tk0d, which are used for starting control for the engine 12, is suspended during execution of fail-safe control when starting the engine 12. In the fail-safe control, the oil path in the hydraulic control circuit 56 is switched so as to supply the clutch actuator 120 with a K0 hydraulic pressure PRk0 that can maintain the completely engaged state of the K0 clutch 20, not via the solenoid valve for the K0 clutch 20, when there occurs a failure in which an adjusted K0 hydraulic pressure PRk0 is not output from the solenoid valve for the K0 clutch 20 in the hydraulic control circuit 56, for example. The K0 hydraulic pressure PRk0 that can maintain the completely engaged state is a source pressure such as a line pressure to be supplied to the solenoid valve for the K0 clutch 20 etc., for example. The base correction pressure has a value obtained by correcting the base pressure for the K0 hydraulic pressure PRk0 to be used for starting control for the engine 12 based on the hydraulic oil temperature THoil etc. On the basis of the base correction pressure for the K0 hydraulic pressure PRk0, it is able to, for example, request a hydraulic pressure being supplied to the K0 clutch 20. The requested K0 torque Tk0d is the K0 torque Tk0 which is requested for cranking of the engine 12 or switching of the K0 clutch 20 to the engaged state during starting control for the engine 12.

The clutch control unit 94 controls the clutch actuator 120 so as to switch the control state of the K0 clutch 20 from the disengaged state to the engaged state based on the phase definition for internal control Dphin, when starting the engine 12.

The start control unit 92d controls the motor MG and the engine 12 in accordance with the control state of the K0 clutch 20, when starting the engine 12. It is conceivable that the start control unit 92d controls the motor MG and the engine 12 based on the phase definition for internal control Dphin, when starting the engine 12. In the starting control for the engine 12, however, it is only necessary that the motor MG should be controlled such that the motor MG outputs the necessary cranking torque Tcrn, and that the engine 12 should be controlled such that the engine 12 starts operation. Therefore, control during starting of the engine may be complicated if the motor MG and the engine 12 are controlled using the phase definition for internal control Dphin which is defined by dividing the control state of the K0 clutch 20 into fine divisions.

Thus, in order to simplify control during starting of the engine 12, a plurality of phases provided for each control state of the K0 clutch 20 among which switching is made in the process of starting the engine 12 is determined in advance in the electronic control unit 90 as phase definition for external disclosure Dphout, or second phase definition, defined for control of the motor MG and the engine 12. In this manner, two types of phase definition, namely the phase definition for internal control Dphin and the phase definition for external disclosure Dphout, are determined in advance in the electronic control unit 90, in order to manage the control state of the K0 clutch 20.

The phase definition for internal control Dphin is prepared for the purpose of calculating the base correction pressure for the K0 hydraulic pressure PRk0 and the requested K0 torque Tk0d, which are used for starting control for the engine 12, for example. Therefore, as illustrated in FIG. 6A and FIG. 6B, timing of transition between phases of the phase definition for internal control Dphin except for “back-up sweep” phase and “calculation suspension” phase is defined based on timing of change in at least one of the base correction pressure for the K0 hydraulic pressure PRk0 and the requested K0 torque Tk0d. In the phase definition for internal control Dphin, the phases are defined based on the state of a request for control for the K0 clutch 20, to control the K0 hydraulic pressure PRk0 and the K0 torque Tk0. That is, the phase definition for internal control Dphin is defined based on a control request for switching the control state of the K0 clutch 20.

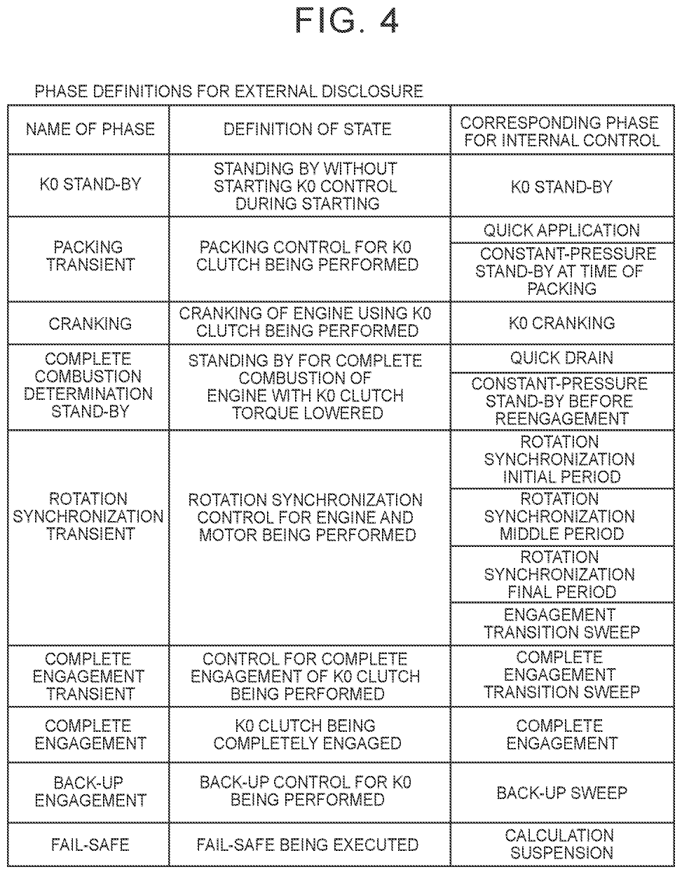

The phase definition for external disclosure Dphout is prepared for the purpose of disclosing (transmitting) the control state of the K0 clutch 20 to control performed by the hybrid control unit 92 in which the phase definition for internal control Dphin is not used. The hybrid control unit 92 is external of the clutch control unit 94. Therefore, as illustrated in FIG. 4, FIG. 6A and FIG. 6B, timing of transition between phases of the phase definition for external disclosure Dphout except for “back-up sweep” phase and “calculation suspension” phase is defined based on any one of: i) timing of change in the requested K0 torque Tk0d; ii) whether a control for the clutch is started or not; and iii) whether a difference between the engine rotational speed Ne and the MG rotational speed Nm satisfies a prescribed condition. In the phase definition for external disclosure Dphout, the phases are defined based on the state of execution of control for the K0 clutch 20, in which the K0 clutch 20 is controlled. That is, the phase definition for external disclosure Dphout is defined based on the control state of the K0 clutch 20 at the time when control for the K0 clutch 20 is executed.

FIG. 4 is a table indicating various phases in the phase definition for external disclosure Dphout. In FIG. 4, the phase definition for external disclosure Dphout defines phases such as “K0 stand-by”, “packing transient”, “cranking”, “complete combustion stand-by”, “rotation synchronization transient”, “complete engagement transient”, “complete engagement”, “back-up engagement”, and “fail-safe”.

The “K0 stand-by” phase in the phase definition for external disclosure Dphout corresponds to the “K0 stand-by” phase in the phase definition for internal control Dphin. The “K0 stand-by” phase in the phase definition for external disclosure Dphout indicates a state in which the control is standing by without starting control for the K0 clutch 20 during starting control for the engine 12.

The “packing transient” phase corresponds to the “quick application” phase and the “constant-pressure stand-by at time of packing” phase in the phase definition for internal control Dphin. The “packing transient” phase indicates that packing control for the K0 clutch 20 is being performed. That is, the “packing transient” phase is a phase to which a transition is made from the “K0 stand-by” phase when control for the K0 clutch 20 is started.

The “cranking” phase corresponds to the “K0 cranking” phase in the phase definition for internal control Dphin. The “cranking” phase indicates that cranking of the engine 12 by the K0 clutch 20 is being performed.

The “complete combustion determination stand-by” phase corresponds to the “quick drain” phase and the “constant-pressure stand-by before reengagement” phase in the phase definition for internal control Dphin. The “complete combustion determination stand-by” phase indicates a state in which the control is standing by for complete combustion of the engine 12 with the K0 torque Tk0 lowered.

The “rotation synchronization transient” phase corresponds to the “rotation synchronization initial period” phase, the “rotation synchronization middle period” phase, the “rotation synchronization final period” phase, and the “engagement transition sweep” phase in the phase definition for internal control Dphin. The “rotation synchronization transient” phase indicates that rotation synchronization control for the engine 12 and the motor MG is being performed.

The “complete engagement transient” phase corresponds to the “complete engagement transition sweep” phase in the phase definition for internal control Dphin. The “complete engagement transient” phase indicates that control for bringing the K0 clutch 20 into the completely engaged state is being performed.

The “complete engagement” phase in the phase definition for external disclosure Dphout corresponds to the “complete engagement” phase in the phase definition for internal control Dphin. The “complete engagement” phase in the phase definition for external disclosure Dphout indicates a state in which the K0 clutch 20 is maintained in the completely engaged state.

The “back-up engagement” phase corresponds to the “back-up sweep” phase in the phase definition for internal control Dphin. The “back-up engagement” phase indicates that back-up control for engaging the K0 clutch 20 is being performed.

The “fail-safe” phase corresponds to the “calculation suspension” phase in the phase definition for internal control Dphin. The “fail-safe” phase indicates a state in which fail-safe control is being executed.

The start control unit 92d controls the motor MG such that the motor MG outputs the necessary cranking torque Tcrn, and controls the engine 12 such that the engine 12 starts operation, based on the phase definition for external disclosure Dphout, when starting the engine 12.

As discussed above, the control state of the K0 clutch 20 is divided into finer divisions in the phase definition for internal control Dphin than in the phase definition for external disclosure Dphout. For example, the phase definition for internal control Dphin has a plurality of phases including the “rotation synchronization initial period”, “rotation synchronization middle period”, and “rotation synchronization final period” phases, which are defined based on the control state of the K0 clutch 20 in a rotation synchronization process for the motor MG and the engine 12. Meanwhile, the phase definition for external disclosure Dphout has the “rotation synchronization transient” phase, which is a phase constituted by integrating the “rotation synchronization initial period”, “rotation synchronization middle period”, and “rotation synchronization final period” phases in the phase definition for internal control Dphin, which are defined based on the control state of the K0 clutch 20 in the rotation synchronization process for the motor MG and the engine 12.

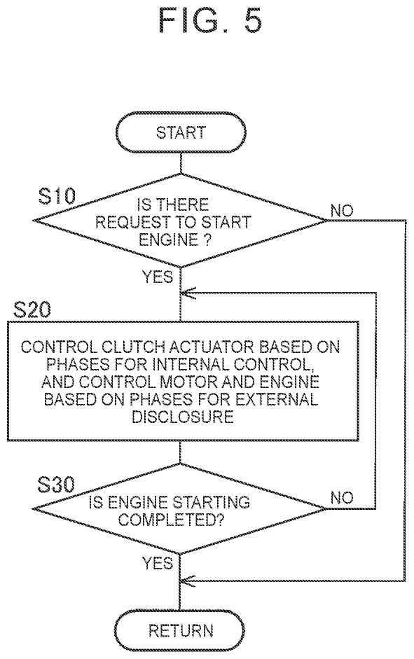

FIG. 5 is a flowchart illustrating an essential portion of control operation of the electronic control unit 90, illustrating control operation for both improving the precision in control during starting of the engine and simplifying the control, the control operation being executed repeatedly, for example. FIG. 6A and FIG. 6B illustrate an example of a time chart for a case where the control operation illustrated in the flowchart in FIG. 5 is executed.

In FIG. 5, first, in step (hereinafter the word “step” will be omitted) S10 which corresponds to the function of the engine start determination unit 92c, it is determined whether there is a request to start the engine 12. When the determination in S10 is denied, the present routine is ended. When the determination in S10 is affirmed, the clutch actuator 120 is controlled based on the phase definition for internal control Dphin, and the motor MG and the engine 12 are controlled based on the phase definition for external disclosure Dphout, in S20 which corresponds to the functions of the clutch control unit 94 and the start control unit 92d. Then, in S30 which corresponds to the function of the engine start determination unit 92c, it is determined whether starting control for the engine 12 is completed. When the determination in S30 is denied, S20 is executed. When the determination in S30 is affirmed, the present routine is ended. When shift control for the automatic transmission 24 is executed during a transition of starting control for the engine 12, shift control for the automatic transmission 24 is executed based on the phase definition for internal control Dphin by the shift control unit 96, for example. During a transition of starting control for the engine 12, in addition, the control state of the LU clutch 40 is basically in the completely disengaged state or the slip state.

FIG. 6A and FIG. 6B illustrate an example of a case where starting control for the engine 12 is executed. In FIG. 6A, “K0 control phase” indicates a transient state of the phases in the phase definition for internal control Dphin. A total hydraulic pressure value obtained by adding a hydraulic pressure value obtained by converting the requested K0 torque Tk0d into the K0 hydraulic pressure PRk0 to a base correction pressure for the K0 hydraulic pressure PRk0 is output as a command value for the K0 hydraulic pressure PRk0. At time t1, a start request for the engine 12 is made and starting control for the engine 12 is started in the EV travel mode, in which the vehicle is stationary in an idle state, or during EV travel. After starting control for the engine 12 is started, the “K0 stand-by” phase (see time t1 to time t2), the “quick application” phase (see time t2 to time t3), and the “constant-pressure stand-by at time of packing” phase (see time t3 to time t4) are executed. The “K0 cranking” phase is executed (see time t4 to time t5) subsequent to packing control for the K0 clutch 20. In the embodiment in FIG. 6A and FIG. 6B, the K0 hydraulic pressure PRk0 which corresponds to the necessary cranking torque Tcrn which is required in the “K0 cranking” phase is applied in the “constant-pressure stand-by at time of packing” phase. In the “constant-pressure stand-by at time of packing” phase, the actual K0 hydraulic pressure PRk0 is not increased to be equal to or more than a value at which the K0 torque Tk0 is generated. In the “K0 cranking” phase, the actual K0 hydraulic pressure PRk0 is increased to be equal to or more than a value at which the K0 torque Tk0 is generated. In the “K0 cranking” phase, the MG torque Tm with a magnitude corresponding to the requested K0 torque Tk0d, that is, the necessary cranking torque Tcrn, is output from the motor MG. When the engine rotational speed Ne is increased in the “K0 cranking” phase, engine ignition etc. is started to cause initial combustion of the engine 12. When ignition starting is performed, initial combustion of the engine 12 is caused generally at the same time as the start of a rise in the engine rotational speed Ne, for example. After initial combustion of the engine 12, the “quick drain” phase (see time t5 to time t6) and the “constant-pressure stand-by before reengagement” phase (see time t6 to time t7) are executed subsequent to the “K0 cranking” phase so that complete combustion of the engine 12 is not disturbed, and a command value for the K0 hydraulic pressure PRk0 which is low is temporarily output. When an engine complete combustion notification is output from the engine control unit 92a (see time t7), the “rotation synchronization initial period” phase (see time t7 to time t8), the “rotation synchronization middle period” phase (see time t8 to time t9), the “rotation synchronization final period” phase (see time t9 to time t10), and the “engagement transition sweep (“engagement transition SW” in the drawing)” phase (see time t10 to time t11) are executed, and rotation synchronization control for the engine 12 and the motor MG is performed. The “complete engagement transition sweep (“complete engagement transition SW” in the drawing)” phase is executed (see time t11 to time t12) subsequent to the “engagement transition sweep” phase, and the K0 torque Tk0 is gradually increased to a state in which a safety factor is added to ensure engagement of the K0 clutch 20. When the K0 torque Tk0 is increased to a state in which a safety factor is added to ensure engagement of the K0 clutch 20, the “complete engagement” phase is executed (see time t12 to time t13), and the completely engaged state of the K0 clutch 20 is maintained. Time t13 indicates the time when starting control for the engine 12 is completed.

As discussed above, in the present embodiment, when starting the engine 12, the clutch actuator 120 is controlled so as to switch the control state of the K0 clutch 20 from the disengaged state to the engaged state based on the phase definition for internal control Dphin which is defined for control for the clutch actuator 120, and the motor MG is controlled such that the motor MG outputs the necessary cranking torque Tcrn, and the engine 12 is controlled such that the engine 12 starts operation, based on the phase definition for external disclosure Dphout which is defined for control for the motor MG and the engine 12. Thus, the clutch actuator 120 and the motor MG and the engine 12 can be separately controlled appropriately in accordance with the control state of the K0 clutch 20. Hence, it is possible to both improve the precision in control during starting of the engine and simplify the control.

In the present embodiment, in addition, the control state of the K0 clutch 20 is divided into finer divisions in the phase definition for internal control Dphin than in the phase definition for external disclosure Dphout. Thus, it is possible to improve the precision in control for the clutch actuator 120, and hence improve the precision in control for the K0 clutch 20, without complicating control for the motor MG and the engine 12 when starting the engine 12.

In the present embodiment, in addition, the phase definition for internal control Dphin has a plurality of phases including the “rotation synchronization initial period”, “rotation synchronization middle period”, and “rotation synchronization final period” phases, and the phase definition for external disclosure Dphout has the “rotation synchronization transient” phase, which is a phase constituted by integrating the “rotation synchronization initial period”, “rotation synchronization middle period”, and “rotation synchronization final period” phases in the phase definition for internal control Dphin. Thus, it is possible to improve the precision in control for the clutch actuator 120, and hence improve the precision in control for the K0 clutch 20, without complicating control for the motor MG and the engine 12 in the rotation synchronization process for the motor MG and the engine 12 when starting the engine 12.

In the present embodiment, in addition, the phase definition for internal control Dphin is defined based on a control request for switching the control state of the K0 clutch 20. Thus, the clutch actuator 120 can be controlled appropriately in accordance with the control state of the K0 clutch 20 which is desired to be controlled. In addition, the phase definition for external disclosure Dphout is defined based on the control state of the K0 clutch 20 at the time when control for the K0 clutch 20 is executed. Thus, the motor MG and the engine 12 can be controlled appropriately in accordance with the actual control state of the K0 clutch 20.

In the present embodiment, in addition, control that is different from engagement control for the K0 clutch 20 can be performed in the course of engagement of the K0 clutch 20 by referencing the control state of the K0 clutch 20 based on the phase definition for internal control Dphin or the phase definition for external disclosure Dphout, which improves the energy efficiency and drivability. In addition, a load of communication among computers etc. can be taken into consideration by disclosing only necessary information on the control state of the K0 clutch 20.

While an embodiment of the present disclosure has been described in detail above with reference to the drawings, the present disclosure is also applicable to other aspects.

For example, in the embodiment discussed above, the engine 12 is started by igniting the engine 12 in accordance with cranking of the engine 12 in a transient state in which the K0 clutch 20 is switched from the disengaged state to the engaged state, and increasing the engine rotational speed Ne of the engine 12 itself. However, the present disclosure is not limited thereto. For example, the engine 12 may be started by igniting the engine 12 after cranking the engine 12 until the K0 clutch 20 is brought to the completely engaged state or a state that is close to the completely engaged state etc. When the vehicle 10 is stationary with the MG rotational speed Nm at zero, the engine 12 can be started by igniting the engine 12 after the engine 12 is cranked by the motor MG with the K0 clutch 20 in the completely engaged state. In the case where the vehicle 10 is provided with a starter which is a motor exclusively for cranking the engine 12, and when the vehicle 10 is stationary with the MG rotational speed Nm at zero and the engine 12 cannot be sufficiently cranked by the motor MG because of an extremely low outside temperature, for example, the engine 12 may be started by igniting the engine 12 after the engine 12 is cranked by the starter.

In the embodiment discussed earlier, an automatic transmission of a planetary gear type is indicated as an example of the automatic transmission 24 which constitutes a part of the power transmission path between the engine 12 and the drive wheels 14 and which transmits a drive force from each of the drive force sources (the engine 12 and the motor MG) to the drive wheels 14. However, the present disclosure is not limited thereto. The automatic transmission 24 may be a known parallel two-axis automatic transmission of a synchronous meshing type including a dual clutch transmission (DCT), a known belt-type continuously variable transmission, etc.

In the embodiment discussed earlier, the torque converter 22 is used as a hydraulic power transmission device. However, the present disclosure is not limited thereto. For example, a different hydraulic power transmission device that does not have a torque amplification function, such as a fluid coupling, may be used as the hydraulic power transmission device in place of the torque converter 22. The hydraulic power transmission device may not necessarily be provided.

The above discussion merely introduces an embodiment, and the present disclosure can be implemented in aspects in which a variety of modifications and improvements are made based on the knowledge of a person skilled in the art.

What is claimed is:

1. A control device for a vehicle including an engine, a motor coupled to a power transmission path between the engine and drive wheels so as to be able to transmit power, and a clutch that is provided between the engine and the motor in the power transmission path and a control state of which is switchable by controlling a clutch actuator, the control device comprising
an electronic control unit configured to:
control the clutch actuator so as to switch the control state of the clutch from a disengaged state to an engaged state, when starting the engine;
control the motor such that the motor outputs torque for increasing a rotational speed of the engine and control the engine such that the engine starts operation, when starting the engine;
control the clutch actuator based on first phase definition that defines a plurality of stages of progress provided for each of control states of the clutch, the clutch being switched among the control states in a process of starting the engine; and
control at least one of the motor and the engine based on second phase definition that defines a plurality of stages of progress, the second phase definition being different from the first phase definition.

2. The control device according to claim 1, wherein the control state of the clutch is divided into finer divisions in the first phase definition than in the second phase definition.

3. The control device according to claim 1, wherein the number of the stages of progress defined by the first phase definition is larger than the number of the stages of progress defined by the second phase definition.

4. The control device according to claim 1, wherein at least one of the stages of progress defined by the second phase definition corresponds to two or more stages of progress defined by the first phase definition.

5. The control device according to claim 1, wherein:
the first phase definition includes a plurality of stages of progress including a rotation synchronization initial period, a rotation synchronization middle period, and a rotation synchronization final period defined based on the control state of the clutch in a rotation synchronization process for the motor and the engine; and
the second phase definition includes a stage of progress corresponding to a period constituted by at least integrating the rotation synchronization initial period, the rotation synchronization middle period, and the rotation synchronization final period.

6. The control device according to claim 1, wherein:
the first phase definition includes a plurality of first stages of progress, timing of transition between the first stages of progress being defined based on timing of change in at least one of a requested hydraulic pressure of the clutch and a requested torque of the clutch; and
the second phase definition includes a plurality of second stages of progress, timing of transition between the second stages of progress being defined based on any one of timing of change in the requested torque of the clutch, whether a control for the clutch is started or not, and whether a difference between a rotational speed of the engine and a rotational speed of the motor satisfies a prescribed condition.

7. The control device according to claim 1, wherein:
the first phase definition is defined based on a control request for switching the control state of the clutch; and
the second phase definition is defined based on the control state of the clutch at a time when a control for the clutch is executed.
